(19) United States
(12) Patent Application Publication
(10) Pub. No.: US 2010/0177991 A1
(43) Pub. Date: Jul. 15, 2010

(54) Packaging material having radio frequency identification function and bag structure using the same

(75) Inventor: Yung-Shun Chen, Chung Li City (TW)

Correspondence Address: BACON & THOMAS, PLLC, 625 SLATERS LANE, FOURTH FLOOR, ALEXANDRIA, VA, 22314-1176, US

(73) Assignee: Taiwan Lamination Industries, Inc., Chung Li City (TW)

(21) Appl. No.: 12/654,729

(22) Filed: Dec. 30, 2009

(30) Foreign Application Priority Data
Jan. 13, 2009 (TW) 098100991

(51) Int. Cl. B65D 30/08; B32B 3/30

(52) U.S. Cl. 383/109; 428/172

(57) ABSTRACT

The present invention is to provide a packaging material having a radio frequency identification (RFID) function and a bag structure using the same, wherein the packaging material comprises a surface material having an inner surface covered with a metal layer (such as aluminum foil), the metal layer has a slot with a width considerably smaller than a length thereof, and two longer side edges of the slot are connected to two feed-in ends of a radio frequency identification (RFID) chip, respectively, so as to form a slot antenna on the metal layer and enable the RFID chip to receive signals of electro-magnetic waves through the slot antenna. Therefore, the packaging material having the RFID function can be easily and speedily manufactured by forming the slot on the metal layer and installing the RFID chip to the corresponding positions of the metal layer.

### FIELD OF THE INVENTION

The present invention relates to a packaging material and a bag structure using the same, more particularly to a packaging material and a bag structure having a metal layer, a slot formed on the metal layer and a radio frequency identification (RFID) having two feed-in ends connected to two longer side edges of the metal layer corresponding to the slot, so as to form the packaging material and bag structure having the RFID function.

### BACKGROUND OF THE INVENTION

Presently, with the progress of electronic industries and the enhancement of telecommunication technologies, various high technologies are gradually applied to human daily life for the purpose of creating more convenient life, wherein a so-called “Radio Frequency Identification (RFID)” system is widely used, and even acknowledged as one of the ten greatest inventions in the 21st century.

Generally, the most common RFID application is to use a reader for emitting a signal of an electro-magnetic wave to trigger an RFID tag within an induction region of the reader, wherein a current is generated by an electro-magnetic induction for driving a chip on the RFID tag. Then, the chip of the RFID tag converts information included therein into a signal of an electro-magnetic wave which will be transmitted to the reader and received by the reader. Therefore, when people purchase products such as foods, medicines, clothes, etc., RFID tags on packaging bags of the products can be directly scanned by the reader, so as to obtain related information of the products pre-stored in the RFID tags, such as the manufacture places, dates, contents, prices, identification data and so on, without asking additional professionals. Thus, the cost of time and manpower of users and providers can be efficiently saved. Furthermore, during the manufacturers fabricate products, the products are loaded into packaging bags, and then paste RFID tags on the packaging bags. A reader can be used to read out information in the RFID tags, so that the manufacturers can efficiently control and manage the quality and production quantity of the products, and carry out the automatic material flow management according to the need of sales. As a result, the real-time information of the products in the supply chain can be tracked, so that the cost can be lowered down, and the transparency of product information can be enhanced, i.e. the RFID tags can substantially increase the efficiency of production management and the material flow distribution of the manufacturers.

The characteristic of the RFID tags is suitably used to control, manage and identify the distribution of products. In addition, because the global unified ISO specification of RFID has been established, various manufacturers develop RFID related technologies in various related industries, in order to occupy more business by the application of RFID tags. For example, widely used RFID tags are described more detail hereinafter. Referring now to FIG. 1, the RFID tag 1 includes an RFID chip 11, a transceiver antenna 13 and a base material 15 (such as polyimide). When manufacturing the RFID tag 1, a flexible copper foil is firstly attached to a side surface of the base material 15 to completely cover the side surface of the base material 15 by an operator. Then, according to the pattern design of the transceiver antenna 13, the flexible copper foil is etched to form the predetermined transceiver antenna 13 by a known etching technique. After this, the RFID chip 11 is connected to a feed-in end of the transceiver antenna 13 by the operator, so that the capability of the RFID chip 11 for receiving signals of electro-magnetic wave can be increased by the transceiver antenna 13. Thus, the RFID tag 1 is finished and can be used by the manufacturers. The operator uses an electronic access device to store related information of a product into the RFID chip 11, and then the RFID tag can be attached to a packaging bag loaded with the product.

However, the process of the RFID tag is complicated, and too much copper foil (i.e. the dotted region as shown in FIG. 1) is wasted during the flexible copper foil is used to form the transceiver antenna 13. Because material cost is raised day by day, the waste of the copper foil is disadvantageous to lower down the manufacture cost of the manufacturers. Moreover, for carrying out the material flow management and the convenience of inspecting products by users, the traditional method is to directly attach the RFID tag to the packaging bag. Thus, the manufacturers must execute a processing step to attach the RFID tag to the packaging bag. However, before finishing the products, the processing step of the traditional method is too complicated, resulting in increasing the processing cost of the products. Besides, because the RFID tag is attached to the outer surface of the packaging bag, the RFID tag influence the original appearance of the packaging bag. Furthermore, if the RFID tag is unsuitably attached, the RFID tag may be damaged or peeled off during processing and transporting the products.

As a result, it is important for related manufacturers to think how to use the existing material of a packaging bag to simultaneously form an RFID tag on the packaging bag during manufacturing the packaging bag, in order to substantially increase the manufacture speed of products, lower down the manufacture cost of the RFID tag, and prevent the RFID tag from being damaged for the purpose of solving the shortcoming of the application of the traditional RFID tag.

It is therefore tried by the inventor to develop a packaging material having a radio frequency identification function and a bag structure using the same to solve the problems existing in the conventional RFID tag that has unduly complicated manufacture process, waste too much material, and may easily influence the appearance of the packaging bag or be peeled from the packaging bag during the processing step of being attached to the packaging bag, as described above.

### BRIEF SUMMARY OF THE INVENTION

A primary object of the present invention is to provide a packaging material having a radio frequency identification (RFID) function, wherein a transceiver antenna of an RFID tag is formed on the existing metal layer of an original packaging material, so as to save additional consumption of material. The packaging material comprises a surface material having an inner surface covered with a metal layer (such as aluminum foil) to increase the strength and the moisture-proof effect of the surface material, wherein the metal layer has a slot with a width considerably smaller than a length thereof, and two longer side edges of the slot of the metal layer are correspondingly connected to two feed-in ends of a radio frequency identification (RFID) chip, respectively, so as to form a slot antenna on the slot of the metal layer. As a result, the RFID chip can receive signals of electro-magnetic waves by the slot antenna to form the packaging material having the RFID function. Therefore, the manufacture only needs to form a slot on the metal layer and install the RFID chip corresponding to the position of the slot of the metal layer, so that the packaging material having the RFID function can be speedily manufactured by one step, so as to substantially increase the manufacture speed of the manufacturer.

A secondary object of the present invention is to provide a packaging bag structure having a radio frequency identification (RFID) function, wherein the packaging bag structure comprises a first packaging material and a second packaging material, and wherein the first packaging material comprises a surface material having an inner surface covered with a metal layer which has a slot with a width considerably smaller than a length thereof, and two longer side edges of the slot of the metal layer are correspondingly connected to two feed-in ends of an RFID chip, respectively, so that the RFID chip can receive signals of electro-magnetic waves by the slot antenna to form the first packaging material having the RFID function, which can be further connected to the second packaging material to form the packaging bag structure having the RFID function. Because the RFID chip and the transceiver antenna (i.e. the slot antenna) are directly formed on the packaging material, the problem of the traditional RFID tag which may be unsuitably attached, damaged or peeled off can be efficiently prevented.

A third object of the present invention is to provide a packaging bag structure having a radio frequency identification (RFID) function, wherein the packaging bag structure is formed by bending a packaging material, and the packaging material comprises a surface material having an inner surface covered with a metal layer which has a slot with a width considerably smaller than a length thereof, and two longer side edges of the slot of the metal layer are correspondingly connected to two feed-in ends of an RFID chip, respectively, so that the RFID chip can receive signals of electro-magnetic waves by the slot antenna to form the packaging material having the RFID function which can further connected to the second packaging material to form the packaging bag structure having the RFID function, which can be further bent and corresponding positions of two inner side edges thereof can be sealed to form the packaging bag structure having the RFID function. Because the packaging bag structure is formed by a single packaging material, the manufacture cost of the manufacturer can be substantially lowered down.

A fourth object of the present invention is to provide a packaging bag structure having a radio frequency identification (RFID) function, wherein the surface material is printed with an ink layer thereon to form various decorative or advertised patterns, so that the manufacturer can use the packaging material to fabricate various types of packaging bag structures. The opaque property of the metal layer can increase the brightness of the decorative patterns and the colors of the ink layer. Furthermore, the metal layer further has a base material thereon, in order to prevent the metal layer or the RFID chip from being damaged and peeled off due to the impact or friction during loading or transporting products, so that the use life of the packaging bag structure can be efficiently increased.

### BRIEF DESCRIPTION OF THE SEVERAL VIEWS OF THE DRAWINGS

The structure and the technical means adopted by the present invention to achieve the above and other objects can be best understood by referring to the following detailed description of the preferred embodiments and the accompanying drawings, wherein

FIG. 1 is a schematic view of a traditional radio frequency identification tag;

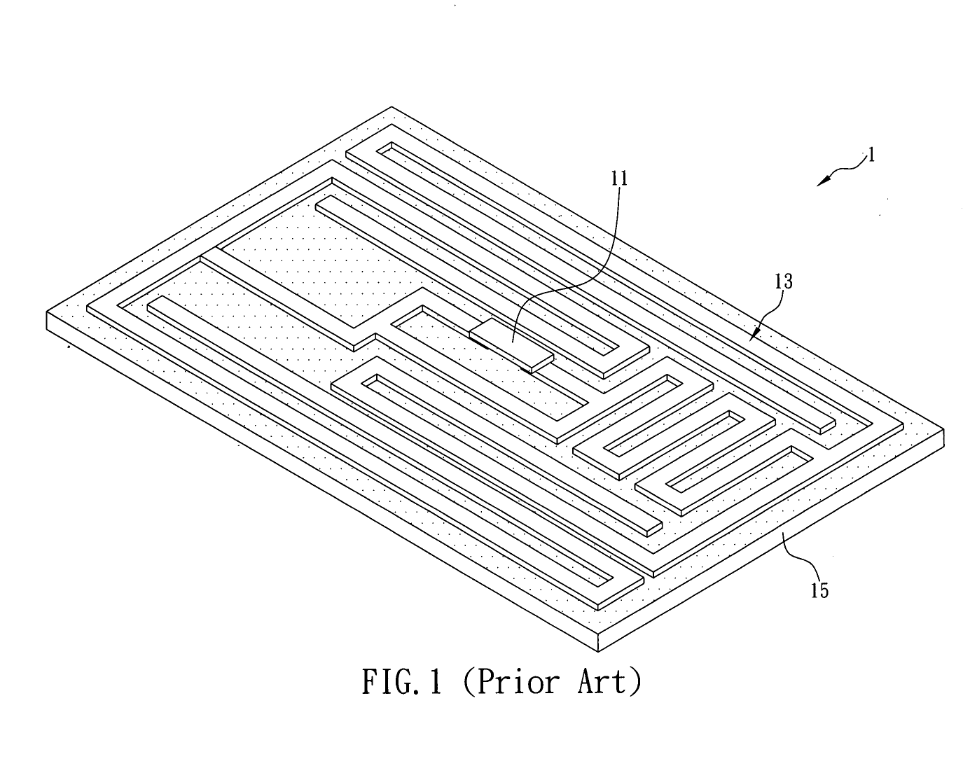

FIG. 2A is a schematic view of a slot antenna according to the present invention;

FIG. 2B is a schematically cross-sectional view of a radiation field of the slot antenna according to the present invention;

FIG. 3A is a schematic view of a packaging bag structure according to a first embodiment of the present invention;

FIG. 3B is a cross-sectional view of the packaging bag structure according to the first embodiment of the present invention;

FIG. 3C is another cross-sectional view of the packaging bag structure according to the first embodiment of the present invention;

FIG. 4A is a schematic view of a packaging bag structure according to a second embodiment of the present invention;

FIG. 4B is a cross-sectional view of the packaging bag structure according to the second embodiment of the present invention;

FIG. 5A is a schematic view of a packaging bag structure according to a third embodiment of the present invention; and

FIG. 5B is a cross-sectional view of the packaging bag structure according to the third embodiment of the present invention.

### DETAILED DESCRIPTION OF THE INVENTION

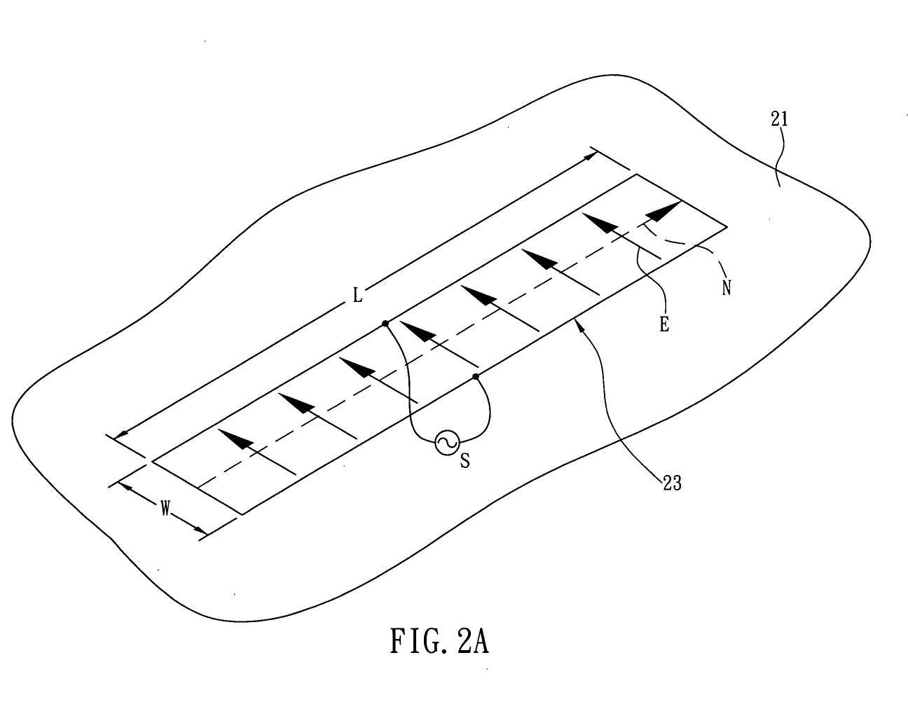

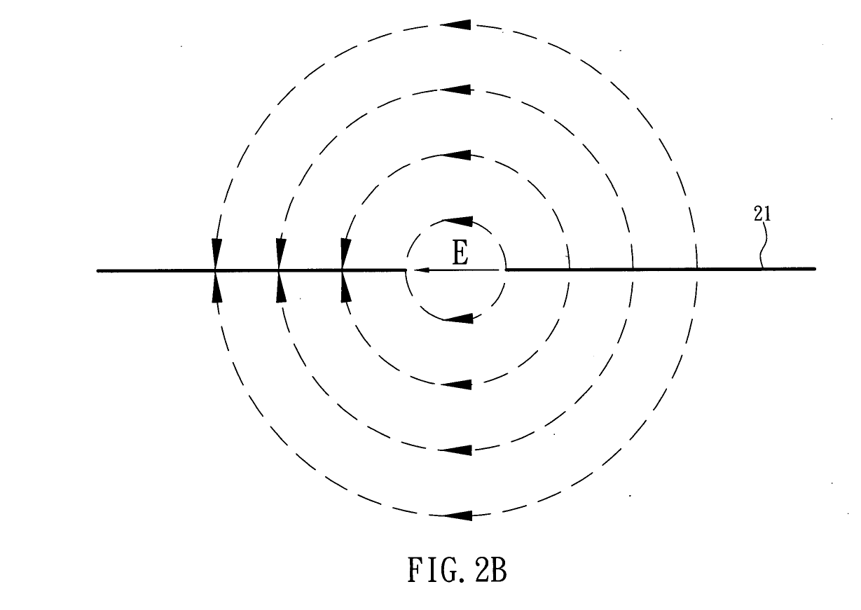

For clearly describing the technological feature of the present invention, the traditional packaging bag structure and the slot antenna used by the present invention are firstly explained before describing the packaging material of the present invention more detailed. Generally, the traditional packaging bag structure comprises at least one packaging material, wherein the packaging material has a surface material which is generally a film made of a plastic material of polyethylene terephthalate (PET). A metal layer, such as aluminum foil, is covered on an inner surface of the surface material to increase the strength of the packaging material. Because the density of the metal layer is greater, the moisture-proof effect of a packaging bag structure can be enhanced after the packaging material is processed to a sealed packaging bag structure. In addition, about the slot antenna, referring now to FIG. 2A, when an unlimited conductor plate 21 is formed with a slot 23, two longer side edges of the slot 23 can be supplied with a current of a power supply S to generate an electric field E and a magnetic field N if the length L of the slot 23 is considerably greater than the width W of the slot 23. Thus, the slot antenna will form a radiation state thereon, as shown in FIG. 2B, so that the slot antenna can provide a function of receiving and transmitting signals of electro-magnetic waves.

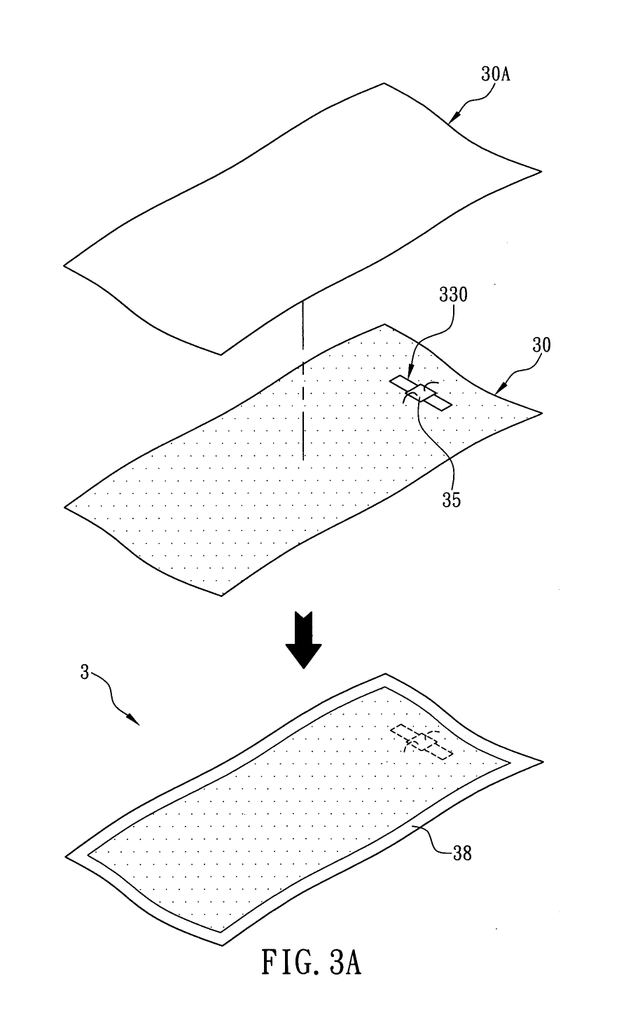

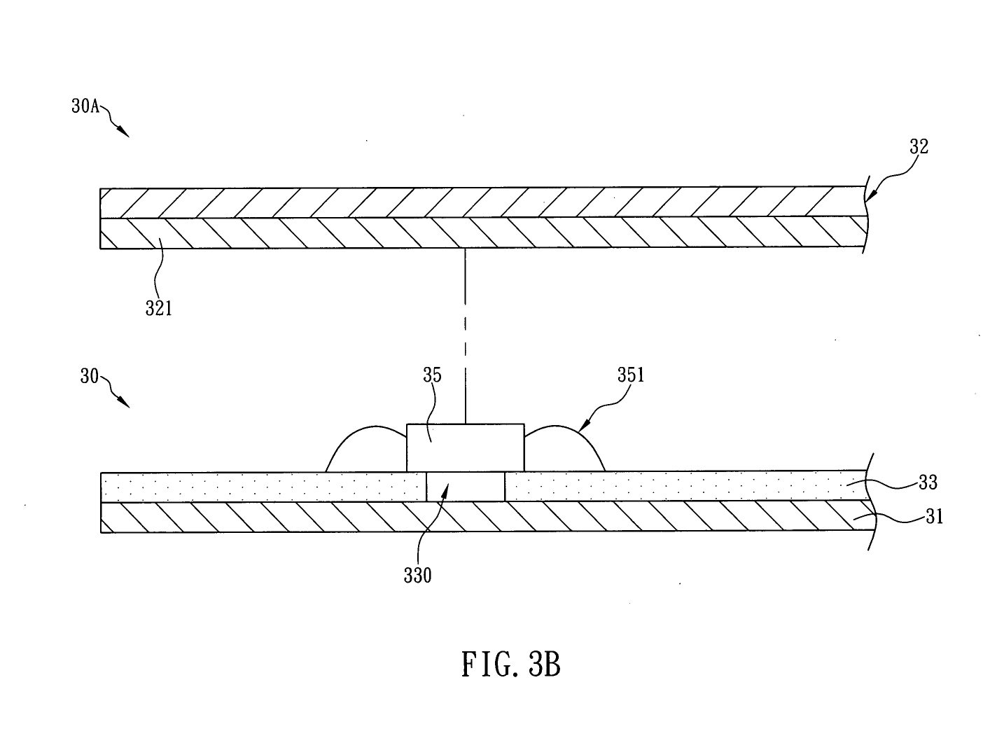

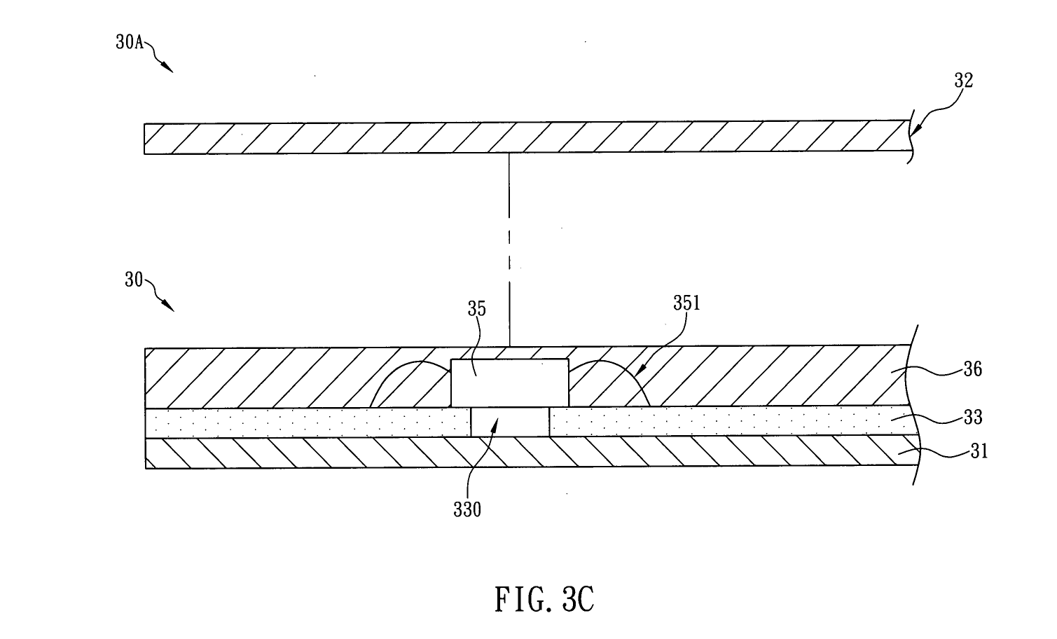

The present invention uses the property of the slot antenna to modify the traditional packaging material, in order to design a packaging material having a radio frequency identification (RFID) function and then use the packaging material to fabricate a packaging bag structure having the RFID function. In a first embodiment of the present invention, referring now to FIG. 3A, the packaging bag structure 3 comprises a first packaging material 30 and a second packaging material 30A. Referring now to FIG. 3B, a cross-sectional view of the first packaging material 30 and the second packaging material 30A is illustrated, wherein the first packaging material 30 has a surface material 31 which is a film made of transparent or translucent plastic material. The surface material 31 has an inner surface covered with a metal layer 33, and the metal layer 33 has an inner surface formed with a rectangular slot 330. Because the area of the metal layer 33 is considerably greater than that of the slot 330, the metal layer 33 is considered as an unlimited conductor plate in comparison with the slot 330, and the width W of the slot 330 is considerably smaller than the length L of the slot 330, so that the slot 330 constructs a slot antenna of the metal layer 33. In addition, a radio frequency identification (RFID) chip 35 has two feed-in ends 351 which are connected to two longer side edges of the slot 330 having a length L greater than the width W thereof, respectively. As a result, the RFID chip 35 can receive signals of electro-magnetic waves of a reader (not-shown) by the slot antenna comprising the metal layer 33 and the slot 330, so that the RFID chip 35 can be driven by the signals. Then, the RFID chip 35 can transmit information stored therein to the reader, so that the first packaging material 30 can provide the RFID function. On the other hand, the second packaging material 30A comprises another surface material 32, and the surface material 32 is a film made of transparent or translucent plastic material. As a result, the manufacturer can seal edges of inner surface of the metal layer 33 and the surface material 32 to form a sealed edge 38, as shown in FIG. 3A, so that the packaging bag structure 3 can be finished. Then, an electronic access device can be used to input product information into the RFID chip 35 of the packaging bag structure 3, so that the packaging bag structure 3 can provide the RFID function. A consumer can clearly identify the content in the packaging bag structure 3 via the second packaging material 30A. Furthermore, in other embodiment of the present invention, if the manufacturer wants to seal the sealed edge 38 of the first and second material 30, 30A more tightly, the inner surface of the surface material 32 can be further covered with a heat sealing layer 321. Thus, the first and second material 30, 30A can be tightly sealed with each other by thermal fusion method, such as high frequency. In the foregoing embodiment, because the manufacturer uses the metal layer 33 existing in the original packaging material to construct the antenna of the RFID chip 35, it doesn't needs additional material to manufacture the antenna. Besides, the RFID tag used by the packaging bag structure 3 of the present invention (i.e. the RFID chip 35 and the metal layer 33) is directly formed on the first packaging material 30, so that the manufacturer needs not execute the traditional process that attaches the RFID tag to the outer surface of the packaging bag. In other words, the process of the packaging bag structure 3 of the present invention can omit one processing step, while the manufacture needs not take care if the RFID tag is unsuitably attached and may be damaged or peeled off during processing and transporting the products. Thus, the manufacture cost of the manufacturer can be efficiently reduced, and the yield of the product can be increased.

As described above, referring still to FIG. 3A, after the first packaging material 30 is installed with the RFID chip 35, the first packaging material 30 is further processed by other steps or transported. Thus, under the unintentional friction or impact of operators, the RFID chip 35 may easily peeled from the first packaging material 30. In addition, if the content of the packaging bag structure 3 is product made of metal material, the metal material may be easily in contact with the two feed-in ends 351 of the RFID chip 35, so as to cause a short circuit problem to affect the function of the RFID chip 35. Hence, to prevent the foregoing problems, referring now to FIG. 3C, another cross-sectional view of the first packaging material 30 and the second packaging material 30A is illustrated, wherein the manufacturer can cover a base material 36 on an inner surface of the metal layer 33 of the first packaging material 30 to increase the stability of the RFID chip 35. Because the base material 36 is also a film made of a plastic material, the first packaging material 30 can be sealed with the inner surface of the second packaging material 30A by thermal fusion method to form a sealed edge 38, as shown in FIG. 3A, so that the packaging bag structure 3 can be finished.

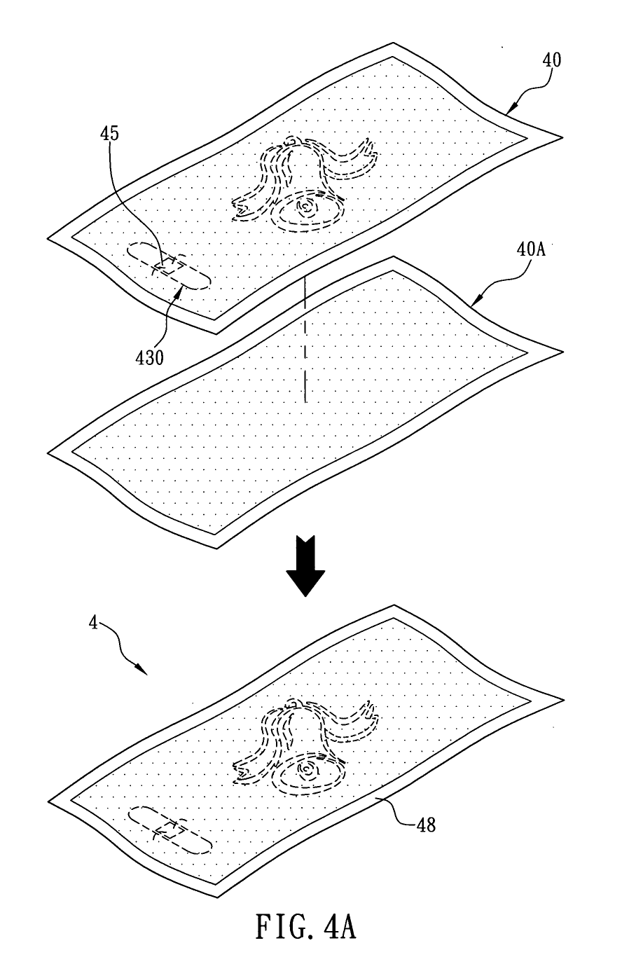

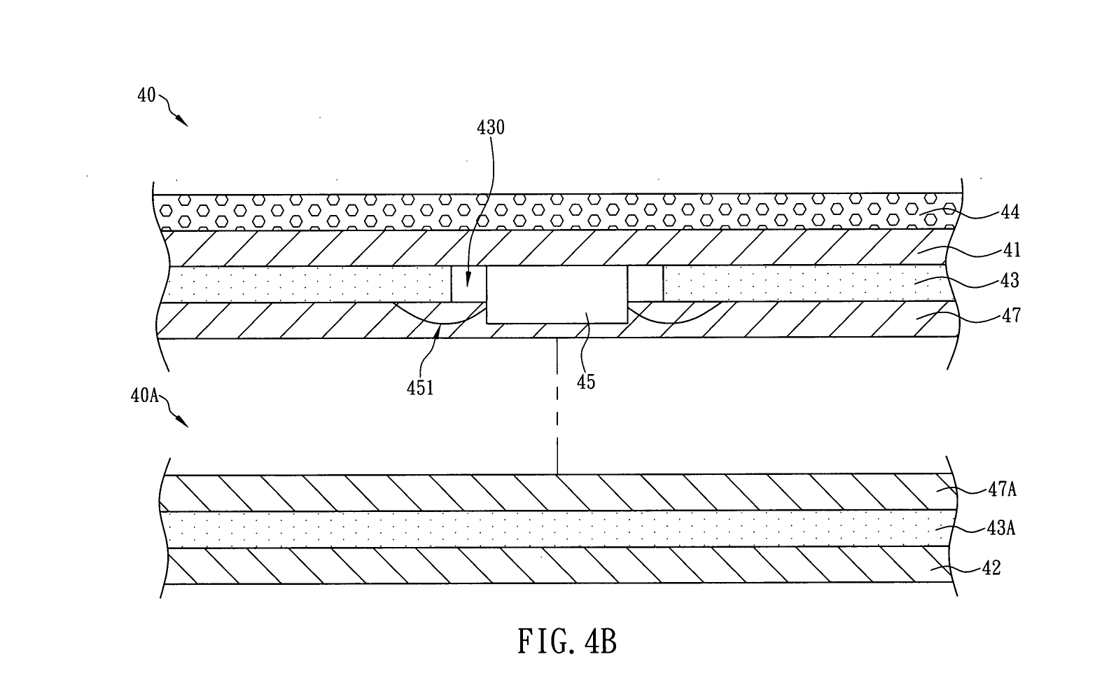

Moreover, when consumers purchase products, the consumers pay attention to the packaging appearance of the products except for usage needs of the products. Therefore, the manufacturer generally designs various colorful decorations or advertised patterns on the packaging bags. In a second embodiment of the present invention, referring now to FIG. 4A, a packaging bag structure 4 comprises a first packaging material 40 and a second packaging material 40A. Referring now to FIG. 4B, a cross-sectional view of the first packaging material 40 and the second packaging material 40A is illustrated, wherein the first packaging material 40 has a surface material 41 which is generally a film made of transparent or translucent plastic material. A metal layer 43 is covered on an inner surface of the surface material 41, while a predetermined gap is defined between the periphery of the metal layer 43 and the periphery of the surface material 41. The metal layer 43 is formed with a long oval slot 430 thereon, wherein the width of the slot 430 is considerably smaller than the length of the slot 430, so as to construct a slot antenna. Two longer side edges of the slot 430 of the metal layer 43 are correspondingly connected to two feed-in ends 451 of a radio frequency identification (RFID) chip 45, respectively, so that the RFID chip 45 can receive signals of electro-magnetic waves by the slot antenna to form the first packaging material 40 having the RFID function. Furthermore, an outer surface of the surface material 41 is printed with an ink layer 44 (by the known surface printing technique) thereon. The ink layer 44 is designed according to fabrication needs of the manufacturer, so as to form various colors and styles. Because the metal layer 43 is opaque, the manufacturer needs not increase the thickness of the ink layer 44, and the ink layer 44 can be fully and completely shown under the metal layer 43. Thus, the consumed material of the ink layer 44 can be reduced, while the color brightness of the ink layer 44 can be increased. As a result, after the first packaging material 40 is processed to the packaging bag structure 4, the ink layer 44 can provide various decorative or advertised patterns on the outer surface of the packaging bag structure 4, so that the manufacturer can conveniently sale the products in the market in the help of the ink layer 44.

In addition, referring to FIG. 4B again, the second packaging material 40A comprises another surface material 42, and the surface material 42 is a film made of transparent or translucent plastic material. An inner surface of the surface material 42 is covered with another metal layer 43A which is used to increase the moisture-proof effect of the packaging bag structure 4 fabricated by the first packaging material 40 and the second packaging material 40A. Besides, to prevent the metal layers 43, 43A from contacting with each other to cause the malfunction of the RFID chip 45 after the packaging bag structure 4 is fabricated, the manufacture can cover a base material 47 (such as film of polyethylene terephthalate) on the metal layer 43 and the inner surface of the surface material 41, wherein the base material 47 is used to completely cover the metal layer 43 and the RFID chip 45, in order to prevent the foregoing problem. If the product loaded in the packaging bag structure 4 is food, the base material 47 also can be prevent the RFID chip 45 from being peeled and accidentally eaten by the consumer. Thus, the manufacturer can seal the inner surface of the first packaging material 40 with the inner surface of the second packaging material 40A by thermal fusion method to form a sealed edge 48 on the packaging bag structure 4, as shown in FIG. 4A. Moreover, referring to FIG. 4B again, to prevent the metal layer 43A of the second packaging material 40A from being partially peeled to contaminate the content of the packaging bag structure 4, the manufacturer can further cover another base material 47A on the metal layer 43A of the second packaging material 40A, so as to increase the usage safety of the packaging bag structure 4.

It should be noted that the manufacturer can connect the first packaging material 40 of the second embodiment to the second packaging material 30A of the first embodiment according to fabrication needs in another embodiment of the present invention. Alternatively, the manufacturer can print the ink layer on the second packaging material 30A of the first embodiment or the second packaging material 40A of the second embodiment, in order to increase the business application of the packaging material of the present invention. In addition, in other embodiments of the present invention, the position of the slot can be disposed at any positions of the metal layer according to the desire of the manufacturer without being limited to the positions as shown in figures of the foregoing embodiments. Thus, during the manufacturer fabricates the packaging material, the packaging bag structure having the RFID function can be speedily manufactured by one step, so as to substantially increase the manufacture speed of the manufacturer.

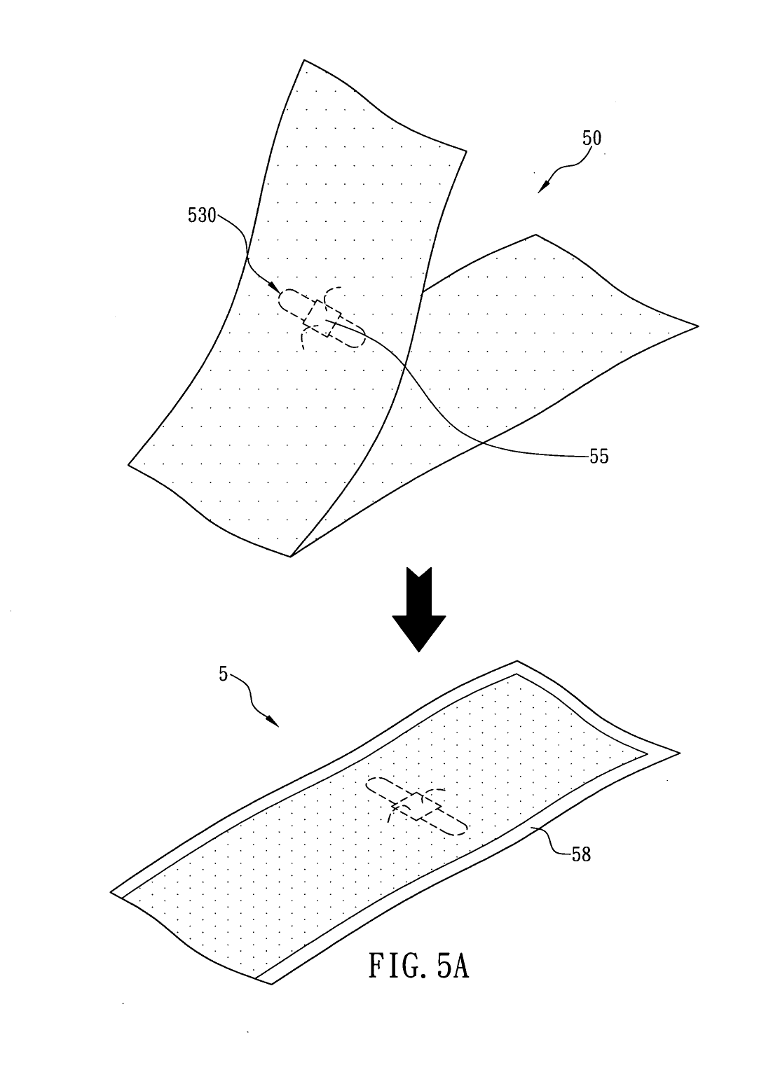

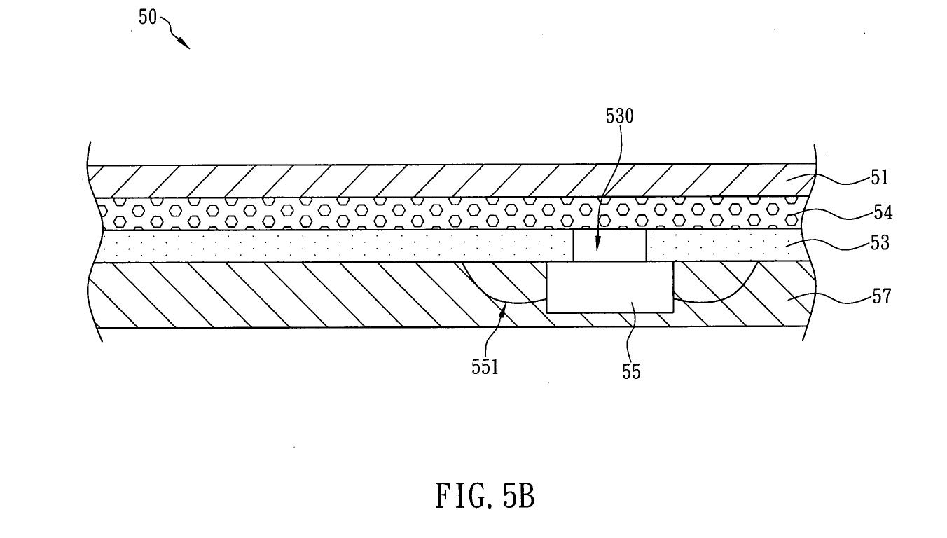

Furthermore, in the third embodiment of the present invention, referring now to FIG. 5A, the packaging bag structure 5 is formed by bending a packaging material 50. Referring now to FIG. 5B, a cross-sectional view of the packaging material 50 is illustrated, wherein the packaging material 50 comprises a surface material 51 which is generally a film made of a plastic material and has an inner surface printed with an ink layer 54 (by the known internal printing technique) thereon. An inner surface of the ink layer 54 is further covered with a metal layer 53 which has a slot 530 with a width considerably smaller than a length thereof, and two longer side edges of the slot 530 of the metal layer 53 are correspondingly connected to two feed-in ends 551 of an RFID chip 55, respectively, so that the metal layer 53 constructs a slot antenna by the slot 530. As a result, the RFID chip 55 can receive and transmit signals of electro-magnetic waves by the slot antenna, so that the packaging material can provide the RFID function. Moreover, an inner surface of the metal layer 53 is covered with a base material 57 which can prevent the RFID chip 55 on the metal layer 53 from being peeled due to possible damage. Besides, after the packaging material 50 is bent, the base material 57 can combine the corresponding inner side edges of the bent packaging material 50 with each other by thermal fusion method, so as to form a sealed edge 58. As a result, the manufacturer needs not fabricate another packaging material, so that the manufacture cost of the manufacturer can be lowered down. However, in other embodiments of the present invention, the manufacturer also can print the ink layer on an outer surface of the surface material.

It should be noted that the application of the present invention is not limited to the structures of the foregoing description and figures, wherein the foregoing embodiments are only some of embodiments of the present invention, so that the actual operation of the present invention is not limited thereto. The person skilled in the art relative to the present invention can understand that the concept of the present invention can vary the manufacturing method of the packaging material and the packaging bag structure thereof by changing the thickness of the surface material or the base material of the packaging material; increasing/decreasing the ink layer, the base material or the sealed layer; or changing the position of the RFID chip on the metal layer of the first or second packaging material. Thus, only if the metal layer of the packaging material is formed with the slot used as the transceiver antenna of the RFID chip to provide the RFID function for the packaging material during manufacturing the packaging material, the product of the packaging material will fall within the scope of the present invention. In addition, the foregoing terms are only used to explain the present invention without limitation thereto.

As described above, the packaging material and the packaging bag structure of the present invention use the metal layer of the traditional packaging material as the transceiver antenna of the RFID chip, so that the manufacturer only needs to form a slot on the metal layer to install an RFID chip spanned across the slot for speedily manufacturing the packaging material or the packaging bag structure having the RFID function by one step without wasting additional cost to use other material to manufacture the RFID tag and additionally process the RFID tag to attach to the packaging bag. As a result, the entire manufacture cost of the packaging material having the RFID function can be lowered down.

The present invention has been described with a preferred embodiment thereof and it is understood that many changes and modifications to the described embodiment can be carried out without departing from the scope and the spirit of the invention that is intended to be limited only by the appended claims.

What is claimed is:

1. A packaging material having a radio frequency identification (RFID) function, the packaging material comprising:
a surface material being a film made of a plastic material;
a metal layer covered on an inner surface of the surface material and having a slot which has a width considerably smaller than a length thereof, so as to form a slot antenna; and
an RFID chip disposed on an inner surface of the metal layer and having two feed-in ends correspondingly connected to two longer side edges of the slot of the metal layer, respectively, so as to form the packaging material.

2. The packaging material according to claim 1, further comprising a base material which is a film made of a plastic material and covered on the inner surface of the metal layer.

3. The packaging material according to claim 1, wherein an outer surface of the surface material is printed with an ink layer thereon.

4. The packaging material according to claim 2, wherein an outer surface of the surface material is printed with an ink layer thereon.

5. The packaging material according to claim 3, wherein the slot is rectangular.

6. The packaging material according to claim 4, wherein the slot is rectangular.

7. A packaging material having a radio frequency identification (RFID) function, the packaging material comprising:
a surface material being a film made of a plastic material;
an ink layer printed on an inner surface of the surface material;
a metal layer covered on an inner surface of the ink layer and having a slot which has a width considerably smaller than a length thereof, so as to form a slot antenna; and
an RFID chip disposed on an inner surface of the metal layer and having two feed-in ends correspondingly connected to two longer side edges of the slot of the metal layer, respectively, so as to form the packaging material.

8. The packaging material according to claim 7, further comprising a base material which is a film made of a plastic material and covered on the inner surface of the metal layer.

9. The packaging material according to claim 8, wherein the slot is rectangular.

10. A packaging bag structure having a radio frequency identification (RFID) function, the packaging bag structure comprising:
a first packaging material comprising:
a surface material being a film made of a plastic material;
a metal layer covered on an inner surface of the surface material and having a slot which has a width considerably smaller than a length thereof, so as to form a slot antenna;
an RFID chip disposed on an inner surface of the metal layer and having two feed-in ends correspondingly connected to two longer side edges of the slot of the metal layer, respectively, so as to form the first packaging material; and
a second packaging material comprising another surface material being a film made of a plastic material, wherein the inner surface of the first packaging material is sealed with an inner surface of the second packaging material to form a sealed edge of the packaging bag structure.

11. The packaging bag structure according to claim 10, wherein the first packaging material further comprises a base material which is a film made of a plastic material and covered on the inner surface of the metal layer of the first packaging material.

12. The packaging bag structure according to claim 11, wherein the second packaging material further comprises another metal layer covered on an inner surface of the surface material of the second packaging material.

13. The packaging bag structure according to claim 10, wherein the second packaging material further comprises another metal layer which is covered on an inner surface of the surface material of the second packaging material, and a base material which is covered on an inner surface of the metal layer of the second packaging material and is a film made of a plastic material.

14. The packaging bag structure according to claim 10, wherein the second packaging material further comprises a heat sealing layer covered on the inner surface of the surface material of the second packaging material.

15. The packaging bag structure according to claim 10, wherein an outer surface of the surface material of the first packaging material is printed with an ink layer thereon.

16. The packaging bag structure according to claim 11, wherein an outer surface of the surface material of the first packaging material is printed with an ink layer thereon.

17. The packaging bag structure according to claim 12, wherein an outer surface of the surface material of the first packaging material is printed with an ink layer thereon.

18. The packaging bag structure according to claim 13, wherein an outer surface of the surface material of the first packaging material is printed with an ink layer thereon.

19. The packaging bag structure according to claim 14, wherein an outer surface of the surface material of the first packaging material is printed with an ink layer thereon.

20. A packaging bag structure having a radio frequency identification (RFID) function, the packaging bag structure comprising:
a first packaging material comprising:
a surface material being a film made of a plastic material;
an ink layer printed on an inner surface of the surface material;
a metal layer covered on an inner surface of the ink layer and having a slot which has a width considerably smaller than a length thereof, so as to form a slot antenna;
an RFID chip disposed on an inner surface of the metal layer and having two feed-in ends correspondingly connected to two longer side edges of the slot of the metal layer, respectively, so as to form the first packaging material; and
a second packaging material comprising another surface material being a film made of a plastic material, wherein the inner surface of the first packaging material is sealed with an inner surface of the second packaging material to form a sealed edge of the packaging bag structure.

21. The packaging bag structure according to claim 20, wherein the first packaging material further comprises a base material which is a film made of a plastic material and covered on the inner surface of the metal layer of the first packaging material.

22. The packaging bag structure according to claim 21, wherein the second packaging material further comprises another metal layer covered on an inner surface of the surface material of the second packaging material.

23. The packaging bag structure according to claim 20, wherein the second packaging material further comprises another metal layer which is covered on an inner surface of the surface material of the second packaging material, and a base material which is covered on an inner surface of the metal layer of the second packaging material and is a film made of a plastic material.

24. The packaging bag structure according to claim 20, wherein the second packaging material further comprises a heat sealing layer covered on the inner surface of the surface material of the second packaging material.

25. A packaging bag structure having a radio frequency identification (RFID) function, formed by bending a packaging material, the packaging material comprising:
a surface material being a film made of a plastic material;
a metal layer covered on an inner surface of the surface material and having a slot which has a width considerably smaller than a length thereof, so as to form a slot antenna;
an RFID chip disposed on an inner surface of the metal layer and having two feed-in ends correspondingly connected to two longer side edges of the slot of the metal layer, respectively; and
a base material being a film made of a plastic material and covered on the inner surface of the surface material and the metal layer, wherein the base material is used to combine corresponding inner side edges of the bent packaging material with each other by a thermal fusion method, so as to form a sealed edge of the packaging bag structure.

26. The packaging bag structure according to claim 25, wherein an outer surface of the surface material is printed with an ink layer thereon.

27. The packaging bag structure according to claim 26, wherein the slot is rectangular.

28. A packaging bag structure having a radio frequency identification (RFID) function, formed by bending a packaging material, the packaging material comprising:
a surface material being a film made of a plastic material;
an ink layer printed on an inner surface of the surface material;
a metal layer covered on an inner surface of the ink layer and having a slot which has a width considerably smaller than a length thereof, so as to form a slot antenna;
an RFID chip disposed on an inner surface of the metal layer and having two feed-in ends correspondingly connected to two longer side edges of the slot of the metal layer, respectively; and
a base material being a film made of a plastic material and covered on the inner surface of the surface material and the metal layer, wherein the base material is used to combine corresponding inner side edges of the bent packaging material with each other by a thermal fusion method, so as to form a sealed edge of the packaging bag structure.

29. The packaging bag structure according to claim 28, wherein the slot is rectangular.
